(19) United States
(12) Patent Application Publication
(10) Pub. No.: US 2023/0140183 A1
(43) Pub. Date: May 4, 2023

(54) GAME CONTROLLER WITH ADJUSTABLE TRIGGER THROW LENGTH

(71) Applicant: Panda Hardware LLC, Spring House, PA (US)

(72) Inventor: Matthew Samperi, Lansdale, PA (US)

(21) Appl. No.: 17/978,367

(22) Filed: Nov. 1, 2022

Related U.S. Application Data
(60) Provisional application No. 63/274,600, filed on Nov. 2, 2021.

(51) Int. Cl. A63F 13/22; A63F 13/24

(52) U.S. Cl. CPC A63F 13/22; A63F 13/24; A63F 2300/1018; A63F 2300/1043

(57) ABSTRACT

A game controller having a trigger button that has a throw length that can be adjusted without opening the controller, i.e., from outside the game controller, such as by using a tool. The trigger button has a rotatable member that is user accessible. The rotatable member is in threaded engagement with a translatable member that is disposed within the game controller. User rotation of the rotatable member causes the translatable member to translate within the trigger button, thereby adjusting the throw length of the trigger button.

### RELATED APPLICATION (PRIORITY CLAIM)

The present application claims the benefit of U.S. Provisional Application Ser. No. 63/274,600, filed Nov. 2, 2021, which is hereby incorporated by reference in its entirety.

### BACKGROUND

The present invention generally relates to game controllers, and more specifically relates to a game controller having a trigger button that has an adjustable throw length.

Throw length is defined as the total distance a trigger button on a game controller needs to move in order to be fully pressed.

Trigger buttons on game controllers have an analog and/or a digital input.

With regard to an analog input, typically a linear analog slider potentiometer is used, wherein the analog input varies depending on how far the trigger button is pressed. More specifically, the throw length typically allows for a range of analog input values (usually 0-255).

On the other hand, with regard to a digital input, the input is only activated when the trigger button is fully depressed.

Sometimes a user will want to have a shorter trigger throw length because they want to be able to activate the digital input without needing to press the button as far.

A typical game controller is not configured to provide that the throw length of a trigger button on the game controller is adjustable. Therefore, to achieve this on a typical game controller, a user would have to open the game controller and add either some material or one or more inserts into the controller, i.e., within the trigger button.

Most game controllers are not configured to be easily opened. As such, a user risks damaging the game controller when the user opens the game controller in an attempt to adjust the throw length of one or more of the trigger buttons by adding either some material or one or more inserts into the controller.

### SUMMARY

One object of an embodiment of the present invention is to provide a game controller having a trigger button that has an adjustable throw length.

Another object of an embodiment of the present invention is to provide a game controller having a trigger button that has a throw length that can be adjusted without opening the controller.

Still another object of an embodiment of the present invention is to provide a game controller having a trigger button that has a throw length that can be adjusted from outside the game controller.

Still yet another object of an embodiment of the present invention is to provide a game controller having a trigger button that has a throw length that can be adjusted from outside the game controller using a tool.

Briefly, an embodiment of the present invention provides a game controller which comprises a trigger button. The trigger button comprises a rotatable member that is user accessible from outside the game controller. The rotatable member is threadably engaged with a translatable member that is disposed within the game controller. User rotation of the rotatable member causes the translatable member to translate within the trigger button, thereby adjusting the throw length of the trigger button.

### BRIEF DESCRIPTION OF THE DRAWINGS

The organization and manner of the structure and operation of the invention, together with further objects and advantages thereof, may best be understood by reference to the following description taken in connection with the accompanying drawings wherein like reference numerals identify like elements in which:

FIG. 1 provides an exterior view of a trigger button of a game controller, where the trigger button is in accordance with an embodiment of the present invention;

FIG. 2 is similar to FIG. 1, but shows inside a trigger assembly;

FIG. 3 is a cross-sectional view of the trigger button shown in FIGS. 1 and 2;

FIGS. 4 and 5 are side cross-sectional views of the trigger button shown in FIG. 1;

FIG. 6 is an exploded perspective view of the trigger button shown in FIG. 1; and FIG. 7 is similar to FIG. 6, but shows the components in cross-section.

### DESCRIPTION

While this invention may be susceptible to embodiment in different forms, there is shown in the drawings and will be described herein in detail, a specific embodiment with the understanding that the present disclosure is to be considered an exemplification of the principles of the invention and is not intended to limit the invention to that as illustrated.

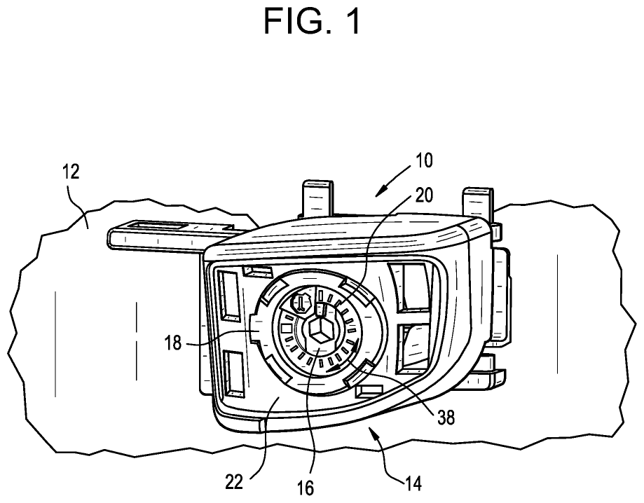

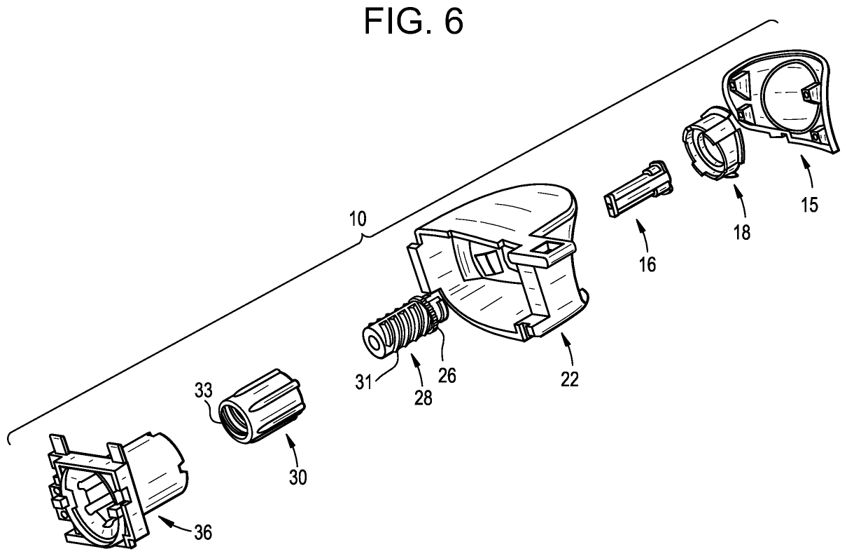

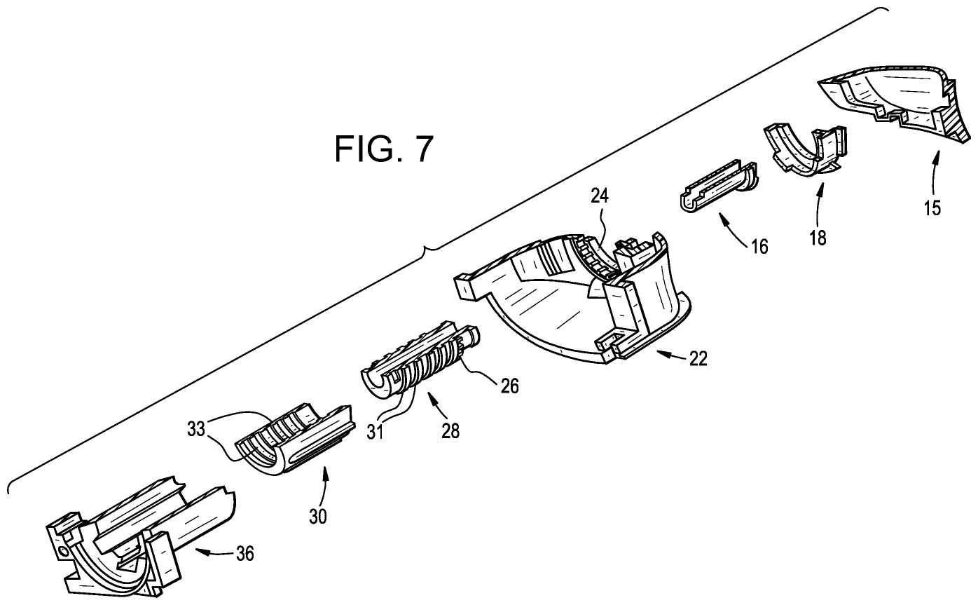

FIG. 1 provides an exterior view of a trigger button 10 of a game controller 12, where the trigger button 10 is in accordance with an embodiment of the present invention. Specifically, FIG. 1 shows the exterior of a trigger assembly 14 after a cap 15 (See FIGS. 6 and 7) has been removed. The cap 15 is what the user touches when pushing down on the trigger button 10. As shown, once the cap is removed, preferably a user interface 16 is exposed. The user interface 16 allows the user to adjust the throw length of the trigger button 10. While FIG. 1 shows the user interface 16 as being an insert for receiving a hex wrench, still other forms of the user interface 16 can be used while still staying within the scope of the present invention. For example, the user interface 16 could instead be a twist knob, a button, a switch, or any other standard user input interface.

As shown, the trigger button 10 includes a retention plate 18 and the retention plate 18 may have indicia 20 thereon relating to the throw length and the position (i.e., rotational setting) of the user interface 16.

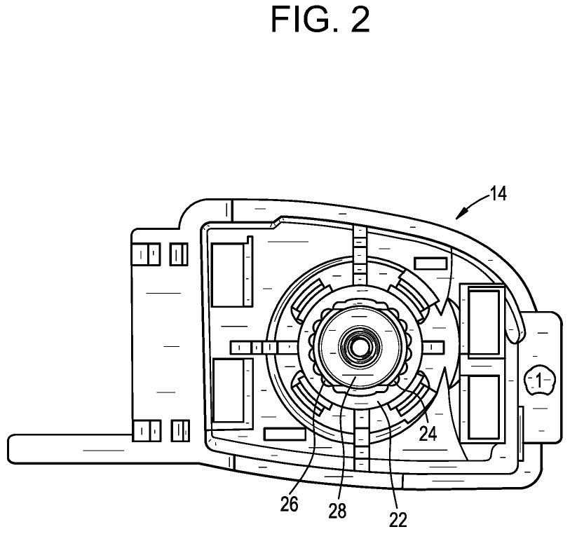

FIG. 2 is similar to FIG. 1 but shows inside the trigger assembly 14 (i.e., inside the trigger enclosure 22). The trigger enclosure 22 preferably comprises teeth 24, such as female teeth, and these teeth 24 are configured to engage corresponding teeth 26, such as male teeth, on a rotatable member such as an inner adjuster 28. In other words, the teeth 24, 26 of the two components collectively act as a gear that provides that the inner adjuster 28 can rotate relative to the trigger enclosure 22 but does not translate relative to the trigger enclosure 22 when rotated. The user interface 16 shown in FIG. 1 is preferably provided in contact with the inner adjuster 28 such that the user can interact with the inner adjuster 28 and rotate the inner adjuster 28 in order to adjust the throw length of the trigger button 10.

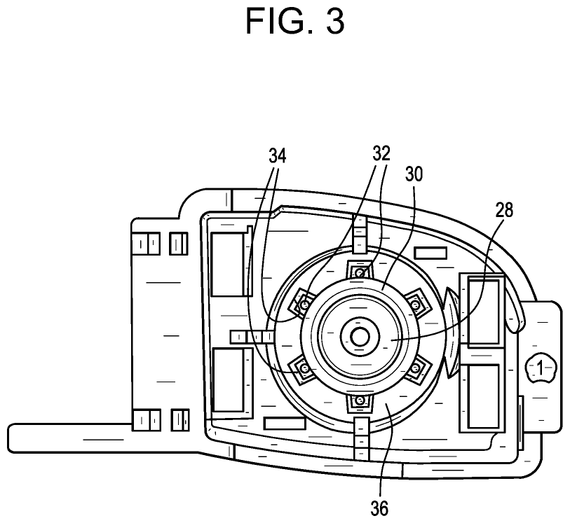

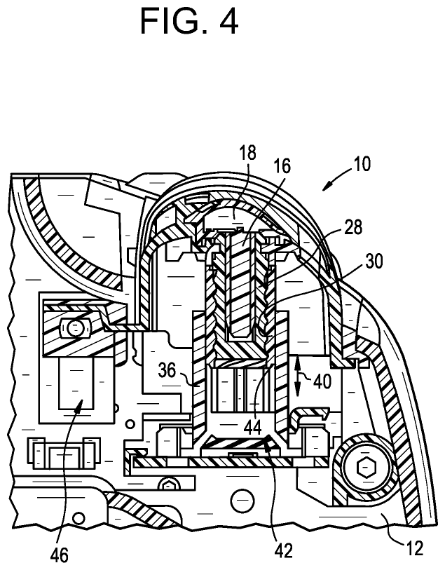

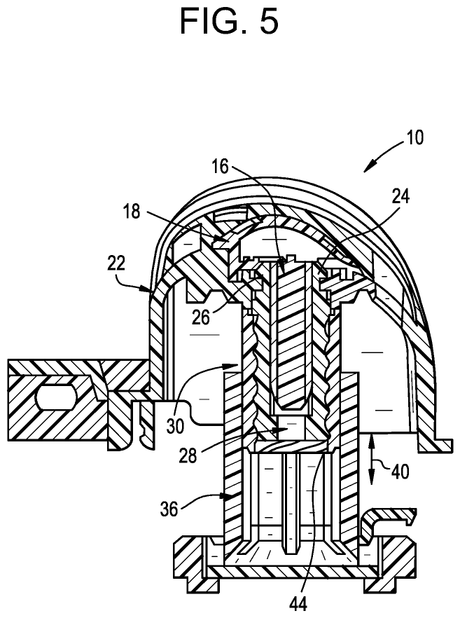

As shown in FIGS. 3-5, in addition to being engaged with the trigger enclosure 22, the inner adjuster 28 is preferably in threaded engagement with an outer adjuster 30 (via external thread 31 on inner adjuster 28 (see FIGS. 6 and 7) interacting with internal thread 33 on outer adjuster 30 (See FIG. 7)), and preferably the outer adjuster 30 includes one or more, such as six (6), wings 32 (see FIG. 3) that effectively key into corresponding slots 34 that are provided in a tube 36 that is disposed inside the trigger enclosure 22. The engagement between the wings 32 on the outer adjuster 30 and the slots 34 in the tube 36 provides that when the inner adjuster 28 is rotated by a user (as indicated by arrow 38 in FIG. 1), the outer adjuster 30 does not rotate but instead translates either up or down within the tube 36 (as indicated by arrow 40 in FIGS. 4 and 5), i.e., up or down depending on which direction the user rotates the inner adjuster 28 via the user interface 16.

As shown in FIG. 4, preferably at the bottom of the trigger button 10, preferably at the bottom of the tube 36, sits a digital trigger input 42, such as a rubberized conductive pad. The more a user rotates the inner adjuster 28 (via the user interface 16) in one direction causing the outer adjuster 30 to translate closer to the digital trigger input 42, the less of a distance the trigger button 10 will need to be pushed for the bottom 44 of the outer adjuster 30 to contact and push down on the digital trigger input 42. Conversely, the more a user rotates the inner adjuster 28 (via the user interface 16) in the other direction causing the outer adjuster 30 to translate further away from the digital trigger input 42, the more of a distance the trigger button 10 will need to be pushed for the bottom 44 of the outer adjuster 30 to contact and push down on the digital trigger input 42. As such, rotation of the inner adjuster 28 in either direction (via the user interface 16) adjusts the throw length of the trigger button 10.

As also shown in FIG. 4, preferably the trigger enclosure 22 is connected to, or otherwise in communication with, a linear analog slider potentiometer 46 or some other appropriate analog measuring device. As such, the trigger button 10 is configured to provide a digital input (using the digital trigger input 42) as well as an analog input (using the linear analog slider potentiometer 46).

As shown in FIGS. 4 and 5, the outer adjuster 30 is disposed inside the tube 36 and ultimately gets pushed down into the tube 36 when a user pushes on the trigger button 10. Preferably, the trigger button 10 is configured to be biased outward (i.e., away from a pushed down position) by one or more springs (not shown). As shown, the inner adjuster 28 preferably extends into (and, as previously discussed, is in threaded engagement with) the outer adjuster 30. As discussed above, the inner adjuster 28 is also in a gear-like engagement with the trigger enclosure 22.

Due to the engagement of the inner adjuster 28 with the trigger enclosure 22, the inner adjuster 28 does not translate when rotated by the user interacting with the user interface 16. Due to the threaded engagement of the inner adjuster 28 with the outer adjuster 30, and due to the one or more wings 32 of the outer adjuster 30 (see FIG. 3) being engaged with the one or more slots 34 in the tube 36, rotation of the inner adjuster 28 (via the user interface 16) causes the outer adjuster 30 to translate either up or down in the tube 36. The position of the bottom 44 of the outer adjuster 30 relative to the digital trigger input 42 at the bottom of the trigger button 10 effectively defines the throw length.

The embodiment of the present invention disclosed herein allows for a user to modify the throw length of the trigger button 10 from the outside of the main controller assembly 12. The advantage of this is that the user does not need to open a controller which most of the time is not made to be opened, possibly damaging the controller, and add something not originally intended for the controller on the inside of it. Instead, the user can customize the throw length from the outside of the controller.

With regard to assembly, the inner adjuster 28 is snapped into a center hole of the trigger enclosure 22. When the inner adjuster 28 snaps in, the inner adjuster 28 becomes fixed translationally, but the inner adjuster 28 can be rotated inside the trigger enclosure 22. When the inner adjuster 28 rotates inside the trigger enclosure 22, the gear teeth engagement between the trigger enclosure 22 and the inner adjuster 28 prevent inadvertent rotation. In other words, the gear teeth engagement prevents inadvertent rotation of the inner adjuster 28 unless enough force is intentionally applied to the user interface 16.

The user interface 16 (such as a hex wrench interface) is then inserted into the inner adjuster 28, which is held in place by the retention plate 18 which is snapped into the trigger enclosure 22 after the user interface 16 is fully inserted. The inner thread 33 of outer adjuster 30 is then threaded onto the outer thread 31 of the inner adjuster 28. As discussed above, the outer adjuster 30 has one or more, such as six (6), twist locking wings 32 along its outer diameter. When fully assembled, the outer adjuster 30 slides inside the tube 36, where it is locked from rotating by the corresponding slots 34 in the tube 36 in which the wings 32 are sitting.

In operation, when the user rotates the user interface 16 (such as by inserting a hex wrench into the user interface 16 and rotating the hex wrench), there will be some resistance from the teeth 26 of the inner adjuster 28 pressing against the teeth 24 of the trigger enclosure 22. Once this resistance is overcome, the inner adjuster 28 rotates to the next tooth of the trigger enclosure 22. The rotation of the inner adjuster 28 causes the outer adjuster 30 to move linearly along the inside of the tube 36 because the outer adjuster 30 is rotationally locked inside the tube 36 and the outer adjuster 30 is connected to the inner adjuster 28 by threads. The linear change in location of the outer adjuster 30 either shortens or lengthens the distance between the bottom 44 of the outer adjuster 30 and the digital trigger input 42. As such, the total distance the bottom 44 of the outer adjuster 30 needs to travel before it hits the digital trigger input 42 (i.e., the throw length) is adjusted.

While a specific embodiment of the invention has been shown and described, it is envisioned that those skilled in the art may devise various modifications without departing from the spirit and scope of the present invention.

What is claimed is:

1. A game controller comprising a trigger button having a throw length, said trigger button comprising a rotatable member that is user accessible from outside the game controller, said trigger button comprising a translatable member that is disposed within the game controller, wherein the rotatable member is threadably engaged with the translatable member, wherein rotation of the rotatable member causes the translatable member to translate within the trigger button, thereby adjusting the throw length of the trigger button.

2. A game controller as recited in claim 1, wherein the trigger button comprises a trigger assembly and a removable cap over the trigger assembly.

3. A game controller as recited in claim 1, wherein the trigger button comprises a user interface, wherein the user interface is configured to provide adjustability of the throw length of the trigger button.

4. A game controller as recited in claim 3, wherein the user interface comprises a hex wrench insert.

5. A game controller as recited in claim 3, wherein the trigger button comprises a retention plate having indicia thereon, wherein the indicia relates to a rotational setting of the user interface.

6. A game controller as recited in claim 1, wherein trigger button comprises a trigger enclosure, wherein the trigger enclosure comprises teeth which engage corresponding teeth on the rotatable member.

7. A game controller as recited in claim 6, wherein trigger button comprises an inner adjuster, wherein the teeth of the trigger enclosure and rotatable member collectively act as a gear that provides that the inner adjuster rotates relative to the trigger enclosure but does not translate relative to the trigger enclosure when rotated.

8. A game controller as recited in claim 7, wherein the user interface is in contact with the inner adjuster, wherein interaction with the inner adjuster rotates the inner adjuster in order to adjust the throw length of the trigger button.

9. A game controller as recited in claim 8, wherein the trigger button further comprises an outer adjuster, wherein the inner adjuster is in threaded engagement with the outer adjuster.

10. A game controller as recited in claim 9, wherein the outer adjuster comprises a plurality of wings that key into corresponding slots in a tube disposed inside the trigger enclosure.

11. A game controller as recited in claim 10, wherein engagement between the wings on the outer adjuster and the slots in the tube provides that when the inner adjuster is rotated, the outer adjuster does not rotate but instead translates either up or down within the tube depending on a direction of rotation of the inner adjuster via the user interface.

12. A game controller as recited in claim 1, wherein the trigger button comprises a digital trigger input and is in communication with an analog measuring device, wherein the trigger button provides a digital input as well as an analog input.

13. A game controller as recited in claim 1, wherein the trigger button is biased outward by at least one spring.

14. A game controller as recited in claim 9, wherein the inner adjuster extends into the outer adjuster.

15. A game controller as recited in claim 7, wherein the inner adjuster snaps into a center hole of the trigger enclosure, wherein the inner adjuster is fixed translationally but is rotatable inside the trigger enclosure.
